(19) United States
(12) Patent Application Publication
(10) Pub. No.: US 2018/0314317 A1
(43) Pub. Date: Nov. 1, 2018

(54) ELECTRONIC DEVICE AND METHOD

(71) Applicants: Kabushiki Kaisha Toshiba, Tokyo (JP); TOSHIBA CLIENT SOLUTIONS CO., LTD., Tokyo (JP)

(72) Inventor: Tomonori Tsutsui, Ome Tokyo (JP)

(21) Appl. No.: 15/878,281

(22) Filed: Jan. 23, 2018

(30) Foreign Application Priority Data
Apr. 27, 2017 (JP) 2017-088658

(51) Int. Cl. G06F 1/32; G06F 1/26

(52) U.S. Cl. CPC G06F 1/3287; G06F 1/266; G06F 1/3218; G06F 1/3212; G06F 1/263

(57) ABSTRACT

According to one embodiment, an electronic device includes: an interface capable of being connected with outside to supply/receive power to/from a first electronic device; a determining processor configured to determine whether the first electronic device supports a switching function based on first information acquired from the first electronic device when the first electronic device is connected to the interface, the switching function being a function to switch whether the first electronic device serves as a source to supply power or serves a sink to receive power; an operational input receiver configured to receive operational input from a user to the electronic device; and a switching processor configured to switch whether the electronic device serves as the source or serves as the sink in accordance with the operational input when the first electronic device is determined to support the switching function.

### CROSS-REFERENCE TO RELATED APPLICATIONS

This application is based upon and claims the benefit of priority from. Japanese Patent Application No. 2017-088658, filed on Apr. 27, 2017; the entire contents of which are incorporated herein by reference.

### FIELD

Embodiments described herein relate generally to an electronic device and a method.

### BACKGROUND

Conventionally, there has been known an electronic device that includes an interface capable of being connected with the outside and supplying power to a connection destination.

In the conventional electronic device as described above, the interface may be configured to be capable of receiving power from the connection destination as well as supplying power to the connection destination. For this kind of the electronic device capable of supplying and receiving power via of the interface, there is a demand that a user can intentionally switch the electronic device at any timing serving as a source to supply power and a sink to receive power.

### BRIEF DESCRIPTION OF THE DRAWINGS

FIG. 1 is an exemplary diagram illustrating appearance of a personal computer (PC) of an electronic device according to one embodiment;

FIG. 2 is an exemplary and schematic block diagram illustrating an internal configuration of the electronic device according to the embodiment;

FIG. 3 is an exemplary diagram illustrating a notification screen displayed on the electronic device when the electronic device serves as a source, according to the embodiment;

FIG. 4 is an exemplary diagram illustrating a notification screen displayed on the electronic device when the electronic device serves as a sink, according to the embodiment;

FIG. 5 is an exemplary flowchart illustrating processing executed by the electronic device when the other electronic device is connected to the electronic device, according to the embodiment;

FIG. 6 is an exemplary flowchart illustrating processing executed by the electronic device when a user performs switching operation, according to the embodiment;

FIG. 7 is an exemplary flowchart illustrating processing executed by the electronic device when the electronic device serves as a source, according to the embodiment; and

FIG. 8 is an exemplary flowchart illustrating processing executed by the electronic device when the electronic device serves as a sink, according to the embodiment.

### DETAILED DESCRIPTION

In general, according to one embodiment, an electronic device includes: an interface capable of being connected with outside to supply/receive power to/from a first electronic device; a determining processor configured to determine whether the first electronic device supports a switching function based on first information acquired from the first electronic device when the first electronic device is connected to the interface, the switching function being a function to switch whether the first electronic device serves as a source to supply power or serves a sink to receive power; an operational input receiver configured to receive operational input from a user to the electronic device; and a switching processor configured to switch whether the electronic device serves as the source or serves as the sink in accordance with the operational input when the first electronic device is determined to support the switching function.

One embodiment will now be described with reference to the accompanying drawings. The configurations of the embodiment described below, and actions and results (effects) caused by the configurations have been presented by way of example, and are not limited to the contents described below.

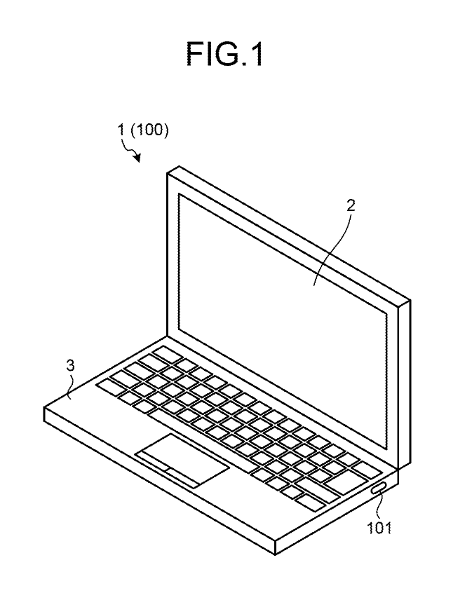

FIG. 1 is an exemplary diagram illustrating appearance of a personal computer (PC) 1 of an electronic device 100 according to an embodiment. As illustrated in FIG. 1, the PC 1 includes a display 2 that displays information such as a moving image, and a main body 3 that includes a processor and a memory provided inside the main body 3 and also includes a keyboard provided thereon. In the embodiment, the main body 3 of the PC 1 is provided with at least one universal serial bus power delivery (USB PD) port 101 that complies with the USB PD standard. It is indisputable that the PC 1 has the same configuration as that of a general computer other than the display 2, the main body 3, and the USB PD port 101. Although FIG. 1 illustrates one example that has a single USB PD port, it may be possible for the electric device 100 to have two or more USB PD ports according to the embodiment.

The USB PD port 101 is an interface configured to be capable of being connected with the outside and supplying/receiving power to/from a connection destination.

In other words, when the USB PD port 101 is connected with the outside, the USB PD port 101 can serve as a source that supplies power to the connection destination or serve as a sink that receives power from the connection destination. According to the embodiment, whether the USB PD port 101 serves as the source or serves as the sink is determined based on a timing when the connection destination of the USB PD port 101 was confirmed. More specifically, the timing is when a negotiation between the electronic device 100 and the connection destination (other electronic device) connected with the electronic device 100 is executed.

In the embodiment, any interface other than the USB PD port 101 may be used if that interface satisfies a condition that the interface is capable of being connected with the outside and the interface is capable of supplying/receiving power to/from a connection destination. As the other embodiment, another electronic device such as a smartphone and a tablet can be applied to, in addition to the PC 1 illustrated in FIG. 1.

Here, a connection destination may be any device such as other PC similar but different from the PC illustrated in FIG. 1, a smartphone, a tablet, an electronic recording device, an audio device, and a video device.

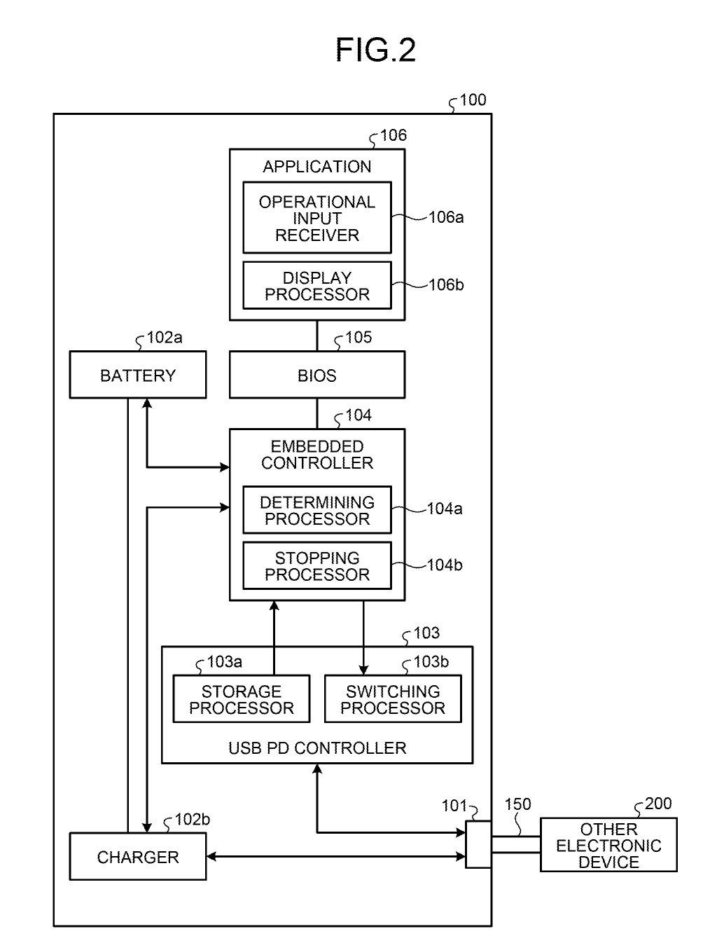

FIG. 2 is an exemplary and schematic block diagram illustrating an internal configuration of the electronic device 100 according to the embodiment. FIG. 2 illustrates one example where the electronic device 100 is connected to an electronic device 200 via a cable 150 that complies with the USB PD standard.

As illustrated in FIG. 2, the electronic device 100 includes the USB PD port 101, a battery 102a, a charger 102b, a USB PD controller 103, and an embedded controller 104, as hardware configuration. FIG. 2 illustrates only the hardware configuration of apart related to the USB PD port 101, but various kinds of hardware configurations in addition to the hardware configuration illustrated in FIG. 2 may be provided in the embodiment.

The battery 102a is a chargeable/dischargeable secondary battery. When the electronic device 100 serves as the sink, the charger 102b charges the battery 102a with power received by the USB PD port 101.

The USB PD controller 103 controls supply/reception of power and transmission/reception of data via the USB PD port 101. More specifically, the USB PD controller 103 controls the supply of power and the transmission of data via the USB PD port 101 when the electronic device 100 serves as a source, and the USB PD controller 103 controls the reception of power and the reception of data via the USB PD port 101 when the electronic device 100 serves as a sink. The USB PD controller 103 includes a processor (not illustrated) that executes various kinds of processing, a memory (not illustrated) that stores therein various kinds of data, and the like.

The embedded controller 104 integrally controls the USB PD controller 103 and the like. Similarly to the USB PD controller 103, the embedded controller 104 also includes a processor (not illustrated) that executes various kinds of processing, a memory (not illustrated) that stores therein various kinds of data, and the like.

Meanwhile, the electronic device 100 includes a basic input/output system (BIOS) 105 and a predetermined application 106 as software configuration. The BIOS 105 is the most basic system program to control various kinds of the hardware configuration included in the electronic device 100. The application 106 implements a predetermined programmed function by use of service provided by the BIOS 105.

In the above-described electronic device 100 capable of supplying/receiving power via the USB PD port 101, it is preferable that a user can switch, at any timing and intentionally, whether the electronic device 100 serves as the source or serves as the sink.

Under the configurations described below, the electronic device 100 of the embodiment can switch, at any timing in accordance with operation (s) by a user, whether the electronic device 100 serves as a source or serves as a sink.

More specifically, in the embodiment, the USB PD controller 103 includes a storage processor 103a and a switching processor 103b, and the embedded controller 104 includes a determining processor 104a and a stopping processor 104b. These configurations may be implemented as a group of functional modules generated on a memory resulting from a predetermined control program executed by processors of the USB PD controller 103 and the embedded controller 104, and may be implemented by dedicated hardware (circuitry).

When the electronic device 100 and the other electronic device 200 are connected to each other, the storage processor 103a acquires first information representing whether the electronic device 200 supports the same function as that of the electronic device 100, and then stores the acquired first information. The same function as that of the electronic device 100 indicates a switching function of switching, at any timing in accordance with operation(s) by a user, whether an electronic device itself serves as the source or serves as the sink.

In the embodiment, transmission and reception of the first information is performed, for example, after the electronic device 100 and the electronic device 200 are connected to each other and at the stage of negotiation before power is actually supplied and received between the electronic device 100 and the electronic device 200. For example, a vender defined message (VDM) defined by the USB PD standard is used for the transmission and the reception of the first information.

The determining processor 104a determines whether the electronic device 200 of the connection destination supports the switching function based on the first information acquired by the storage processor 103a. When the electronic device 200 is determined to support the switching function, the switching processor 103b switches whether the electronic device 100 serves as a source or serves as a sink in accordance with operational input by a user by use of a power roll swap control function implemented by the USB PD standard.

The operational input of a user is received by an operational input receiver 106a implemented as one function of the application 106. The operational input receiver 106a receives operational input via a touch panel (not illustrated), other physical operation switches, operation buttons, and the like.

Further, in the application 106 of the embodiment, a display processor 106b is also implemented. The display processor 106b controls output of a moving image to a display included in the electronic device 100 such as the display 2 illustrated in FIG. 1.

In the embodiment, when the electronic device 200 is determined not to support the switching function, the display processor 106b displays, on the display, a screen for notifying a user that the electronic device 200 does not support the switching function. By contrast, when the electronic device 200 is determined to support the switching function, the display processor 106b displays, on the display, a notification screen 300 for notifying a user whether the electronic device 100 serves as the source or serves as the sink in relation with the electronic device 200.

For example, when the electronic device 100 serves as the source in relation with the electronic device 200 of the connection destination, the display processor 106b displays the following notification screen 300a.

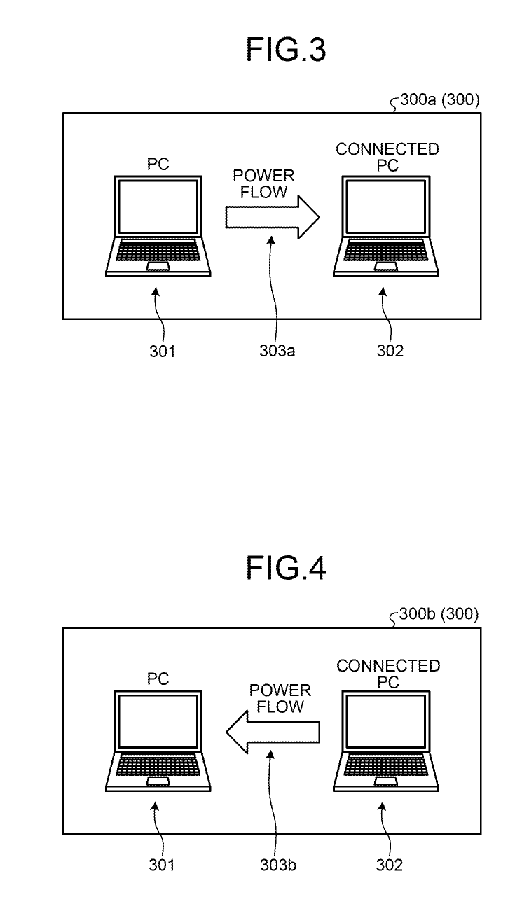

FIG. 3 is an exemplary diagram illustrating the notification screen 300a displayed on the electronic device 100 when the electronic device 100 serves as the source, according to the embodiment. As illustrated in FIG. 3, the notification screen 300a includes display 301 accompanied with a character string of “PC” representing the electronic device 100, display 302 accompanied with a character string of “connected PC” representing the electronic device 200 of the connection destination, and display 303a representing a flow of power between the electronic device 100 and the electronic device 200.

As described above, the notification screen 300a illustrated in FIG. 3 is displayed when the electronic device 100 serves as the source. Therefore, in the example of FIG. 3, the display 303a representing the flow of power is displayed as an arrow directed from the display 301 representing the electronic device 100 toward the display 302 representing the electronic device 200.

On the other hand, when the electronic device 100 serves as the sink in relation with the electronic device 200 of the connection destination, the display processor 106b displays the following notification screen 300b.

FIG. 4 is an exemplary diagram illustrating the notification screen 300b displayed on the electronic device 100 when the electronic device 100 serves as the sink, according to the embodiment. As illustrated in FIG. 4, the notification screen 300b includes the same configuration as that of the notification screen 300a illustrated in FIG. 3. In other words, the notification screen 300b includes the display 301 representing the electronic device 100, the display 302 representing the electronic device 200 of the connection destination, and display 303b representing the flow of power between the electronic device 100 and the electronic device 200.

Unlike the notification screen 300a illustrated in FIG. 3, the notification screen 300b illustrated in FIG. 4 is displayed when the electronic device 100 serves as the sink. Therefore, in the example of FIG. 4, the display 303b representing the flow of power is displayed as an arrow directed from the display 302 representing the electronic device 200 toward the display 301 representing the electronic device 100.

Thus, according to the embodiment, a user can understand the flow of power between the electronic device 100 and the electronic device 200 and easily recognize whether the electronic device 100 serves as a source or serves as a sink by only looking at the notification screen 300. In the embodiment, an operation button for switching the source/sink of the electronic device 100 may be implemented as a graphical user interface (GUI) provided to the notification screen 300.

The electronic device 100 of the embodiment also has a function of monitoring a residual amount of the battery 102a and constantly securing the residual amount of the battery 102a by a certain value or more. For example, when the electronic device 100 serves as the source, it is not preferable that the residual amount of the battery 102a excessively decrease from a viewpoint of securing an operation time of the electronic device 100. In addition, when the electronic device 100 serves as the sink, even if the residual amount of the battery 102a is secured by the certain value or more, it may be preferable to stop the electronic device 100 receiving power for securing the operation time of the electronic device 100 of a supplier of power.

Therefore, in the embodiment, the stopping processor 104b monitors the residual amount of the battery 102a, and stops supply of power via the USB PD port 101 to stop the electronic device 100 serving as the source when the residual amount is equal to or less than a first threshold in a case where the electronic device 100 serves as the source. Also, the stopping processor 104b monitors the residual amount of the battery 102a, and stops reception of power via the USB PD port 101 to stop the electronic device 100 serving as the sink when the residual amount is equal to or more than a second threshold in a case where the electronic device 100 serves as the sink.

Meanwhile, in the embodiment, the electronic device 100 may preliminarily have setting information that defines whether the electronic device 100 serves as the source or serves as the sink by default when the other electronic device 200 is connected to the electronic device 100. In this case, it is preferable that the setting information is stored as information that can be optionally changed by a user. With this configuration, supply and reception of power can be easily achieved along with intention of a user.

Under the configurations described above, in the embodiment, control operation described below is implemented.

The following describes a flow of processing executed when the other electronic device 200 is connected to the electronic device 100.

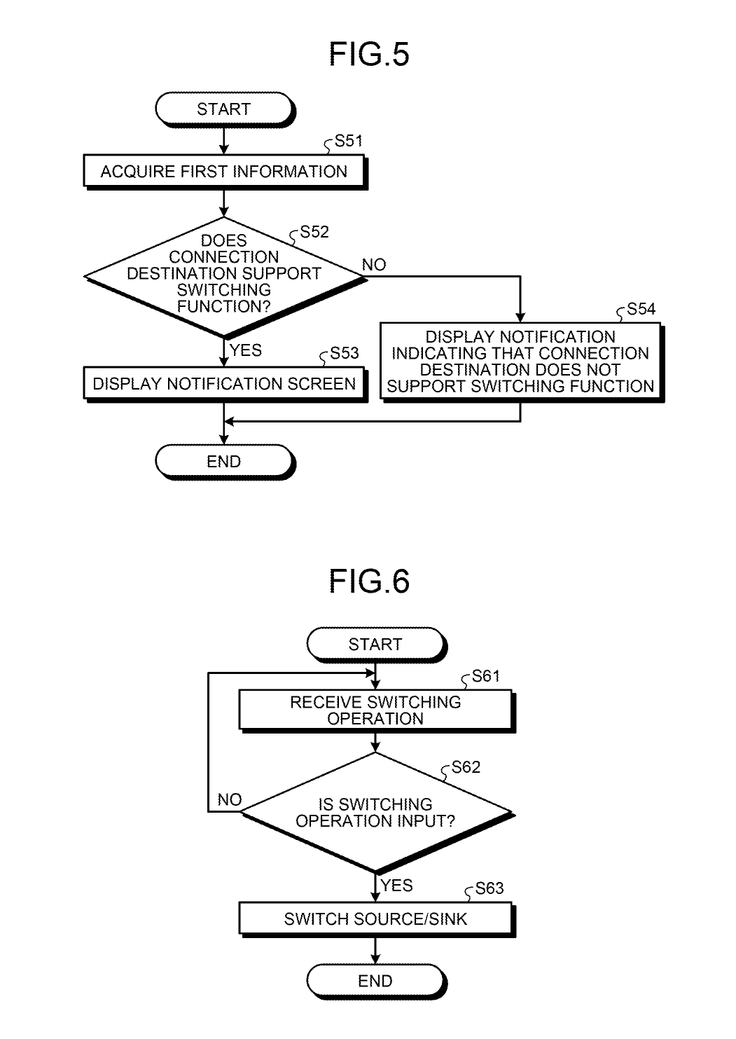

FIG. 5 is an exemplary flowchart illustrating processing executed by the electronic device 100 when the other electronic device 200 is connected to the electronic device 100, according to the embodiment.

In the processing flow illustrated in FIG. 5, the storage processor 103a acquires, from the electronic device 200 of a connection destination, the first information representing whether the electronic device 200 supports the same switching function as that of the electronic device 100 at S51.

At S52, the determining processor 104a determines whether the electronic device 200 of the connection destination supports the switching function based on the first information acquired at S51.

When the connection destination is determined to support the switching function at S52, the processing goes to S53. At S53, the display processor 106b displays the notification screen 300 for notifying a user whether the electronic device 100 currently serves as the source or serves as the sink. And then, the processing ends.

By contrast, when the connection destination is determined not to support the switching function at S52, the processing goes to S54. At S54, the display processor 106b displays a screen and the like for notifying that the other electronic device 200 connected to the electronic device 100 does not support the switching function. And then, the processing ends.

The following describes a flow of processing executed when a user performs switching operation for switching the source/sink of the electronic device 100 in a state where the notification screen 300 is displayed.

FIG. 6 is an exemplary flowchart illustrating processing executed by the electronic device 100 when a user performs the switching operation, according to the embodiment.

In the processing flow illustrated in FIG. 6, the operational input receiver 106a receives the switching operation performed by a user at S61. This switching operation can be input via a touch panel (not illustrated), other physical operation switches, operation buttons, and the like.

At S62, the determining processor 104a determines whether the switching operation performed by a user is input. When the switching operation is determined not to be input at S62, the processing goes back to S61. However, when the switching operation is determined to be input at S62, the processing goes to S63.

At S63, the switching processor 103b switches the source/sink of the electronic device 100. For example, when the electronic device 100 currently serves as the source, the switching processor 103b replaces a master-slave relationship of supplying/receiving power between the electronic device 100 and the other electronic device 200 to make the electronic device 100 serve as the sink. Similarly, when the electronic device 100 currently serves as the sink, the switching processor 103b replaces the master-slave relationship of supplying/receiving power to make the electronic device 100 serve as the source. And then, the processing ends.

The following describes a flow of processing executed when the electronic device 100 of the embodiment serves as the source.

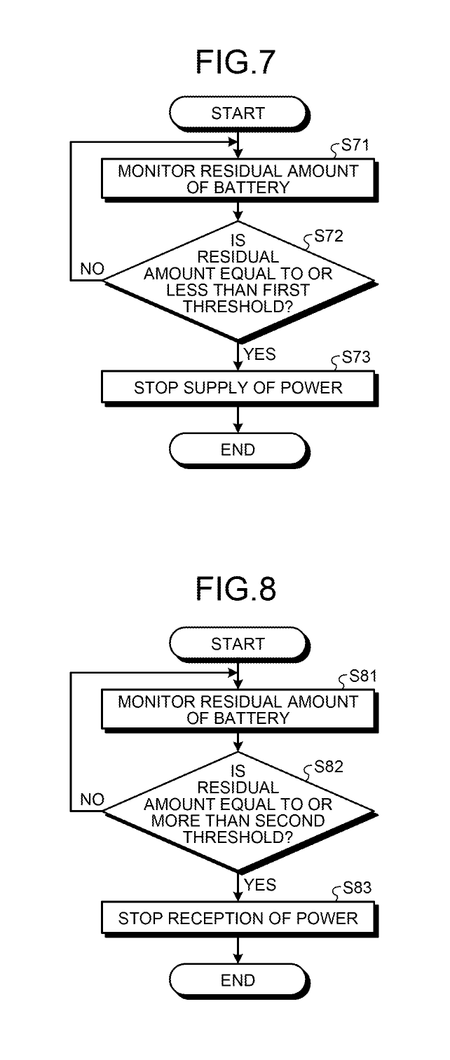

FIG. 7 is an exemplary flowchart illustrating processing executed by the electronic device 100 when the electronic device 100 serves as the source, according to the embodiment.

In the processing flow illustrated in FIG. 7, the stopping processor 104b monitors a residual amount of the battery 102a at S71. The stopping processor 104b determines whether the residual amount of the battery 102a is equal to or less than the first threshold at S72.

When the residual amount of the battery 102a is determined to be more than the first threshold at S72, the processing goes back to S71. By contrast, when the residual amount of the battery 102a is determined to be equal to or less than the first threshold at S72, the processing goes to S73.

In the embodiment, the residual amount of the battery 102a that is equal to or less than the first threshold indicates that an operation time of the electronic device 100 cannot be sufficiently secured if the electronic device 100 keeps supplying power to the electronic device 200. Therefore, in this case, the stopping processor 104b stops the electronic device 100 serving as the source and stops supply of power to the electronic device 200 at S73. And then, the processing ends.

The following describes a flow of processing executed when the electronic device 100 of the embodiment serves as the sink.

FIG. 8 is an exemplary flowchart illustrating processing executed by the electronic device 100 when the electronic device 100 serves as the sink, according to the embodiment.

In the processing flow illustrated in FIG. 8, the stopping processor 104b monitors a residual amount of the battery 102a at S81. The stopping processor 104b determines whether the residual amount of the battery 102a is equal to or more than the second threshold at S82.

When the residual amount of the battery 102a is determined to be less than the second threshold at S82, the processing goes back to S81. By contrast, when the residual amount of the battery 102a is determined to be equal to or more than the second threshold at S82, the processing goes to S83.

In the embodiment, the residual amount of the battery 102a that is equal to or more than the second threshold indicates that a certain operation time of the electronic device 100 can be secured even when the electronic device 100 stops reception of power from the electronic device 200. Therefore, in this case, the stopping processor 104b stops the electronic device 100 serving as the sink and stops reception of power from the electronic device 200 at S83. And then, the processing ends.

As described above, the electronic device 100 of the embodiment includes the USB PD port 101 as an interface capable of being connected with the outside and supplying/receiving power to/from a connection destination. Further, the electronic device 100 includes the determining processor 104a, the operational input receiver 106a, and the switching processor 103b. The determining processor 104a is configured to determine whether the electronic device 200 supports the same switching function as that of the electronic device 100 based on the first information acquired from the electronic device 200 when the other electronic device 200 is connected to the USB PD port 101. The operational input receiver 106a is configured to receive operational input from a user to the electronic device 100. The switching processor 103b is configured to switches whether the electronic device 100 serves as the source or serves as the sink in accordance with the operational input from a user when the electronic device 200 is determined to support the switching function. With this configuration, whether the electronic device 100 serves as the source or serves as the sink can be switched at any timing in accordance with operation(s) by a user.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
an interface capable of being connected with outside to supply/receive power to/from a first electronic device;
a determining processor configured to determine whether the first electronic device supports a switching function based on first information acquired from the first electronic device when the first electronic device is connected to the interface, the switching function being a function to switch whether the first electronic device serves as a source to supply power or serves a sink to receive power;
an operational input receiver configured to receive operational input from a user to the electronic device; and
a switching processor configured to switch whether the electronic device serves as the source or serves as the sink in accordance with the operational input when the first electronic device is determined to support the switching function.

2. The electronic device of claim 1, further comprising:
a display processor configured to display, on a display, as to whether the electronic device serves as the source or serves as the sink.

3. The electronic device of claim 2, wherein
the display processor is configured to display, on the display, a flow of power between the electronic device and the first electronic device.

4. The electronic device of claim 2, wherein
the display processor is configured to display, on the display, a notification that indicates impossibility of switching whether the electronic device serves as the source or serves as the sink in a case where the first electronic device is determined not to support the switching function.

5. The electronic device of claim 1, further comprising:
a battery configured to be chargeable/dischargeable; and
a stopping processor configured to monitor a residual amount of the battery, and to stop the electronic device serving as the source when the residual amount is equal to or less than a first threshold in a case where the electronic device serves as the source.

6. The electronic device of claim 1, further comprising:
a battery configured to be chargeable/dischargeable; and
a stopping processor configured to monitor a residual amount of the battery, and to stop the electronic device serving as the sink when the residual amount is equal to or more than a second threshold in a case where the electronic device serves as the sink.

7. The electronic device of claim 1, wherein
the interface complies with the universal serial bus power delivery (USB PD) standard.

8. A method executed by an electronic device that comprises an interface capable of being connected with outside to supply/receive power to/from a first electronic device, the method comprising:
determining whether the first electronic device supports a switching function based on first information acquired from the first electronic device when the first electronic device is connected to the interface, the switching function being a function to switch whether the first electronic device serves as a source to supply power or serves as a sink to receive power;
receiving operational input from a user to the electronic device; and
switching whether the electronic device serves as the source or serves as the sink in accordance with the operational input when the first electronic device is determined to support the switching function.

9. The method of claim 8, further comprising:
displaying, on a display, as to whether the electronic device serves as the source or serves as the sink.

10. The method of claim 9, further comprising:
displaying, on the display, a flow of power between the electronic device and the first electronic device.

11. The method of claim 9, further comprising:
displaying, on the display, a notification that indicates impossibility of switching whether the electronic device serves as the source or serves as the sink in a case where the first electronic device is determined not to support the switching function.

12. The method of claim 8, further comprising:
monitoring a residual amount of a battery, and stopping the electronic device serving as the source when the residual amount is equal to or less than a first threshold in a case where the electronic device serves as the source, the battery being configured to be chargeable/dischargeable and comprised in the electronic device.

13. The method of claim 8, further comprising:
monitoring a residual amount of a battery, and stopping the electronic device serving as the sink when the residual amount is equal to or more than a second threshold in a case where the electronic device serves as the sink, the battery being configured to be chargeable/dischargeable and comprised in the electronic device.

14. The method of claim 8, wherein
the interface complies with the universal serial bus power delivery (USB PD) standard.
